(19) United States
(12) Patent Application Publication
(10) Pub. No.: US 2005/0190325 A1
(43) Pub. Date: Sep. 1, 2005

(54) Method and devices for controlling optical phase delay utilizing electrically tuned liquid crystal nano-structures

(76) Inventor: Suning Tang, Fremont, CA (US)

Correspondence Address: CHARLES QIAN, 1018 CRANBERRY DR., CUPERTINO, CA, 95014, US

(21) Appl. No.: 10/788,933

(22) Filed: Feb. 27, 2004

(51) Int. Cl. G02F 1/1335

(52) U.S. Cl. 349/117

(57) ABSTRACT

A method and devices for obtaining optical phase delay utilizing electrically tuned liquid crystal nano-structures are disclosed. In one preferred embodiment, an electrically tuned liquid crystal nano-structure provides optical phase delay. The disclosed device consists of cover plates, electrodes, nanometer scaled structures with polymer regions and regions filled with liquid crystal materials, and the controlling electronic circuit. By adjusting the applied electric field in the liquid crystal nano-structure, different polarization components of the incoming light will experience different phase delays without changing their propagating direction. In another preferred embodiment, an optical polarization tuner based on aforementioned electrically tuned liquid crystal nano-structures is disclosed. The polarization tuner consists of an polarization beam splitter, two electrically tuned liquid crystal nano-structures, and two beam folding prisms. By adjusting the applied electrical fields through the two liquid crystal nano-structures, light outputs with different polarization states are obtained. In yet another preferred embodiment, a spatial light modulator device based on aforementioned electrically tuned liquid crystal nano-structures is disclosed. The spatial light modulator consists of a nano-structured liquid crystal, a multi-channel electrode structure and controlling electronic circuit. The multi-channel electrode structure can be used to establish different electrical fields in different spatial regions such that the phase of the incoming light can be modified with spatial specificity.

### BACKGROUND OF THE INVENTION

1. Field of the Invention

The present invention relates generally to nano-structured liquid crystal devices and more particularly to a method and devices for controlling optical phase delays through electrically tuned liquid crystal nano-structures.

2. Background Art

Currently, new technologies are enabling the fabrications of structures less than the wavelength of visible and ultra violet light (i.e., structures with features less than 200 nm). Such nano-structures will in turn enable new devices, apparatus and systems to be developed and induce more new technologies. The present invention relates to nano-structures containing liquid crystal (LC) materials and relates closely to conventional LC materials and in particular, electrically switched LC gratings. There are several prior art LC technologies and the most relevant patents to the present invention appear to be U.S. Pat. No. 6,563,966 to Tang, and U.S. Pat. No. 5,937,115 to Domash. These patents are thereby included herein by ways of reference.

A typical prior art LC phase retarder is illustrated in FIG. 1. The LC phase retarder consists of two cover glasses 110, coated with inside rubbing layers 120, a space between the two cover glasses 130, and LC particles 140. Normally the LC retarder is sandwiched in between two transparent electrodes (not shown). In the absence of an external field, the LC particles have pre-aligned orientations parallel to alignment layers whereas their orientations will rotate to align up in the presence of an external electrical field. The strength of the electrical field determines the degree of re-alignment of the LC particles. Since LC materials have orientation dependent index of refraction, the apparent index of refraction of the LC phase retarder therefore changes as a function of the voltage across. The rubbing layer helps LC particles to maintain their alignments. In FIG. 2, a prior art electrically switched (ES) LC based Bragg's grating is illustrated. The ES Bragg's grating consists of two covering glasses 210, regions of polymers 220, LC regions 230 interleaved with polymer regions. The LC regions contain LC particles 240 whose orientations are aligned perpendicular to polymer-LC interface in the absence of an external electric field and can be re-aligned parallel to the polymer-LC interface in the presence of an external electric field. The Bragg's grating formed by interleaved polymer-LC regions is sandwiched between two electrodes 250 and an electrical field is established when two electrodes are subjected to different potentials (voltages). The incoming beam 260 contains two orthogonal polarization components. The Bragg's grating transmits one of the polarization components 280 while diffracting the other component 280. The wave-vectors of the incoming and diffracted beams follow the Bragg Condition, i.e., kᵢₙ±Ω=k_{d}, where Ω is the wave-vector associated with the LC grating.

There are several areas that can be improved on these prior art LC phase retarders. For instance, the need of rubbing layers in a conventional LC phase retarder significantly increased its manufacturing costs. Another issue is that larger LC particles need to be used in these prior art LC devices and hence substantially limits their respond speed. There is a need therefore to have improvements to these prior arts such that faster LC phase retarders can be made in a simplified device scheme and fabrication process.

### SUMMARY OF THE INVENTION

The present invention discloses an improved method and devices to obtain optical phase delay utilizing electrically tuned LC nano-structures. In accordance with one of the preferred embodiments, an electrically tuned liquid crystal nano-structure is used to obtain optical phase delay. The disclosed device consists of cover plates, electrodes, nanometer scaled structures with polymer regions and LC regions, and the controlling electronic circuit. By adjusting the applied electric field in the liquid crystal nano-structure, different polarization components of the incoming light will experience different phase delay without altering their propagating direction.

In another preferred embodiment, an optical polarization tuner based on aforementioned electrically tuned liquid crystal nano-structures is disclosed. The polarization tuner consists of an polarization beam splitter, two electrically tuned liquid crystal nano-structures, and two beam folding prisms. By adjusting the applied electrical fields through the two liquid crystal nano-structures, light outputs with different polarization states are obtained.

In an additional preferred embodiment, a spatial light modulator device based on aforementioned electrically tuned liquid crystal nano-structure is disclosed. The spatial light modulator consists of a nano-structured liquid crystal, a multi-channel electrode structure and controlling electronic circuit. The multi-channel electrode structure can be used to establish different electrical fields in different spatial regions such that the phase of incoming light can be modified with spatial specificity.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows the cross section of a prior art LC phase retarder;

FIG. 2 illustrates the cross section of an electrically switched LC Bragg's grating;

FIG. 3A and FIG. 3B depict an improved LC phase retarder;

FIG. 4 displays an improved optical polarization tuner utilizing two electrically tuned LC phase retarders, a polarization beam splitter, and two reflective prisms;

FIG. 5 illustrates an improved spatial light modulator consisting of electrically tuned LC phase retarders, and an array optical transparent electrodes.

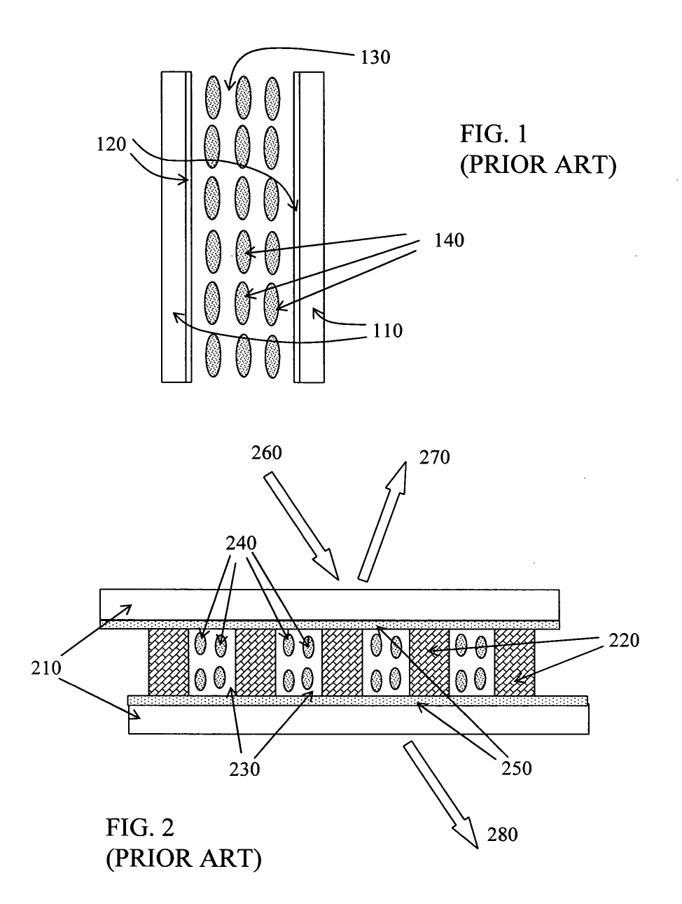

### DETAILED DESCRIPTION OF THE INVENTION

The present invention discloses a new method and devices to obtain optical phase delay utilizing an electrically tuned LC nano-structures. The new method departs from the prior art practice of micrometer and millimeter LC structures. The basic concept is to establish alternating nanometer sized regions of polymers and LC materials. Due to its high spatial resolution, such a nano structure will not diffract the incoming light. The orientations of the LC particles are self-aligned perpendicular to the polymer-LC interfaces. As a result, no alignment (rubbing) layers are required as in the case of a prior art LC phase retarder. The orientations of the LC particles can be rotated (re-aligned) in an external electrical field and thereby providing a tunable phase delay. The substantially reduced dimensions of these LC regions also improves LC device tuning speed. The new approach provides a simplified, one step manufacturing process that is easier to implement.

The present invention utilizes Electrically Tuned Liquid Crystal Nano-structures (ETLCN) that are constructed using holographic polymer dispersed with liquid crystal (LC) regions. The mechanism of operation of these ETLCN is based on refractive index changes of the LC particles induced by an external electrical field. Polymer-LC interface aligned LC particles and electrically re-aligned LC particles exhibit different refractive indices. Application of an electric field re-aligns the LC particles and alters the refractive index of the region. The polymer regions provide internal rubbing layers necessary for the operation of the LC regions. The degree of alignment of the LC particles depends sensitively on the strength of the applied electrical field and tuning is realized by adjusting the applied voltages.

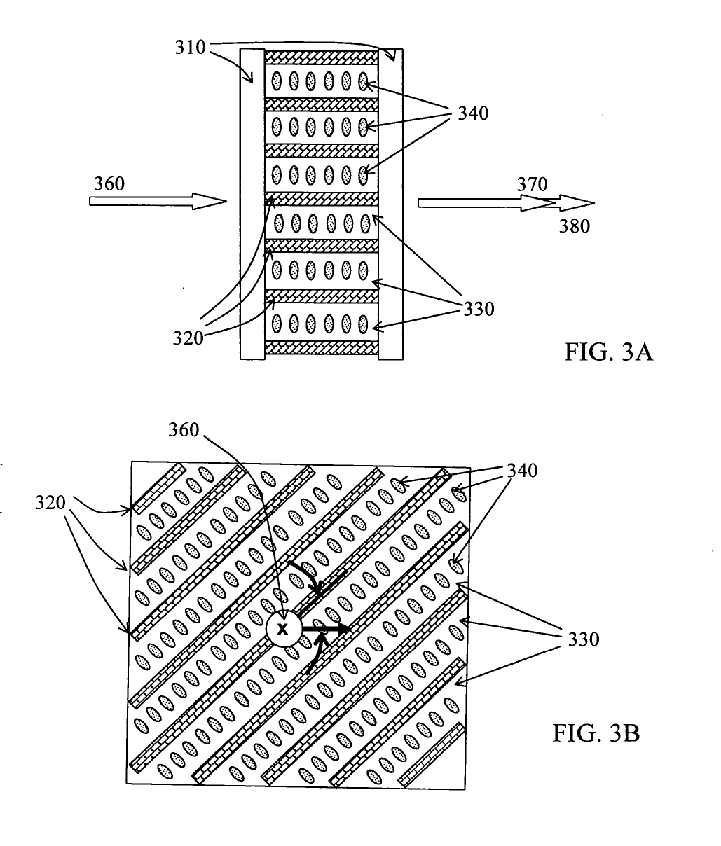

The first preferred embodiment of the present invention is illustrated in FIGS. 3A and 3B. An ETLCN device consists of two cover glass plates (310), alternating regions of polymer (320) and LC (330) with period substantially less than the wavelength of operation. The cover glass plates are normally coated with an indium-tin-oxide layer to form transparent electrodes (not shown). The liquid crystal particles (340) can be re-aligned in the presence of an external field. The incoming light (360) transmits through the ETLCN device with a minimum loss. In the presence of an external electrical field, one polarization component of the transmitted light (370) will be subject to more phase delay than the other polarization component (380). The amount of delay depends sensitively on the strength of the applied electrical field and the orientation angle between the incoming light field and the nano-structure as illustrated in accordance with FIG. 3B. The phase delay of a particular device can be related to change of the index of refraction in accordance with the following relation ΔT=Δn×L/c, where Δn is the index of change of the device, L is the geometrical path length along the light propagation direction, and c is the speed of the light in vacuum. The change of the index of refraction is related only to the LC particles and can be related to the percentage of the areas covered by LC regions in accordance with the following relationship: Δn=Δn(LC)×% (LC). Where Δn(LC) is the change of the index of refraction associated with the LC regions only.

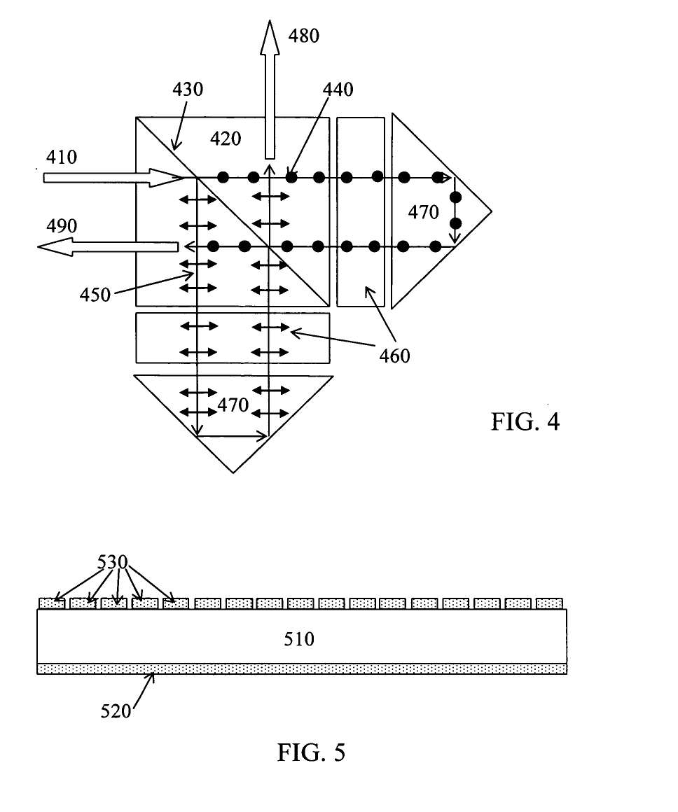

The second preferred embodiment of the present invention is illustrated in FIG. 4. An optical polarization tuner based on aforementioned ETLCN devices is disclosed. The polarization tuner consists of a polarization beam splitter (420), two electrically tuned liquid crystal nano-structures (460), and two beam folding prisms (470). The input light (410) with a predetermined polarization state enters the polarization tuner and a polarization beam splitter coating (430) separates different polarization components (440, 450). By adjusting the applied electrical fields through the two liquid crystal nano-structures, light outputs with different phase delay and intensities (480, 490) are obtained.

In accordance with another preferred embodiment of the present invention as displayed in FIG. 5, a spatial light modulator device based on aforementioned ETLCN structure is disclosed. The spatial light modulator consists of a nano-structured liquid crystal 510, a multi-channel electrode structure (530, 520) and controlling electronic circuit (not shown). The multi-channel electrode structure can be used to establish different electrical fields in different spatial regions such that the phase of the incoming light can be modified with spatial specificity.

It will be apparent to those with ordinary skill of the art that many variations and modifications can be made to the method and devices to obtain phase delayed optical outputs disclosed herein without departing form the spirit and scope of the present invention. It is therefore intended that the present invention cover the modifications and variations of this invention provided that they come within the scope of the appended claims and their equivalents,

1. An optical phase delay device for providing phase delayed optical outputs comprising:
at least two parallel covering plates having a physical separation in between;
regions of polymer materials spaced by a distance substantially smaller than one micrometer;
regions of liquid crystal particles interleaving the said regions of polymers;
and a group of electrodes being fabricated near the said covering glass plates.

2. The optical phase delay device recited in claim 1 wherein the said covering plates being glass plates.

3. The optical phase delay device recited in claim 1 wherein the said liquid crystal regions having an ordinary refractive index nₒ and an extraordinary refractive index nₑ.

4. The optical phase delay device recited in claim 1 wherein the said polymer regions having an index of refraction nₚ.

5. The optical phase delay device recited in claim 1 wherein the said polymer regions and liquid crystal regions being fabricated through a photolithography method.

6. The optical phase delay device recited in claim 1 wherein the said liquid crystal regions containing liquid crystal materials.

7. The optical phase delay device recited in claim 1 wherein the said polymer regions and liquid crystal regions being fabricated through a photolithography method using patterned phase masks and/or using patterned holographic two beam interference methods.

8. The optical phase delay device recited in claim 1 wherein the said electrodes being fabricated with electrically conductive materials such as metals, ITO (Indium-Tin oxide), and/or conductive polymeric mixtures.

9. The optical phase delay device recited in claim 1 wherein the said electrodes being fabricated through a photolithography method.

10. The optical phase delay device recited in claim 1 wherein the said cover plate being optically coupled to at least one polarization beam splitters.

11. The optical phase delay device recited in claim 1 wherein the said cover plate being optically coupled to at least one prism.

12. The optical phase delay device recited in claim 1 wherein the said polymer regions having separations measuring from 1 to 1000 nanometers.

13. The optical phase delay device recited in claim 1 wherein the said cover plates having a separation distance of 1 micrometers to 500 micrometers.

14. A method for providing optical phase delay comprising the following steps:
using a collimated light source having specific wavelength;
passing the input light to an electrically tuned liquid crystal nano-structure consisting of alternating polymer and liquid crystal regions;
applying electrical voltages to electrodes near the said liquid crystal nano-structure to tune the said optical phase delay.

15. The method recited in claim 14 wherein the said liquid crystal regions having an ordinary refractive index nₒ and an extraordinary refractive index nₑ.

16. The method recited in claim 14 wherein the said polymer regions having an index of refraction nₚ.

17. The method recited in claim 14 wherein the said polymer regions and liquid crystal regions being fabricated through a photolithography method.

18. The method recited in claim 14 wherein the said liquid crystal regions containing liquid crystal materials.

19. The method recited in claim 14 wherein the said polymer regions and liquid crystal regions being fabricated through a photolithography method using patterned phase masks and/or using holographic two beam interference methods.

20. The method recited in claim 14 wherein the said the said electrodes being fabricated with electrically conductive materials such as metals, ITO (Indium-Tin oxide), and/or conductive polymeric mixtures.

21. The method recited in claim 14 wherein the said liquid crystal regions being optically coupled to at least one polarization beam splitters.

22. The method recited in claim 14 wherein the said polymer regions having separations measuring from 1 to 1000 nanometers.

23. The method recited in claim 14 wherein the said cover plates having a separation distance of 1 micrometers to 500 micrometers.
